(19) United States
(12) Patent Application Publication
(10) Pub. No.: US 2006/0173726 A1
(43) Pub. Date: Aug. 3, 2006

(54) Online business case software and decision support system

(76) Inventors: William M. Hall, Standish, ME (US); Richard D. Whitcomb, Scarborough, ME (US)

Correspondence Address: CESARI AND MCKENNA, LLP, 88 BLACK FALCON AVENUE, BOSTON, MA, 02210, US

(21) Appl. No.: 11/314,886

(22) Filed: Dec. 20, 2005

Related U.S. Application Data
(60) Provisional application No. 60/648,499, filed on Jan. 31, 2005.

(51) Int. Cl. G06F 9/46

(52) U.S. Cl. 705/8

(57) ABSTRACT

The present invention provides an on-line computer systems (herein defined to include software) that includes processes, technologies, facilities to manage comprehensively a “project.” Management defined as spanning the time from the idea or inception that inspired the project to the resulting products' or processes' ends-of-life. The system provides a central data depository for data and information generated or gleaned from others that bear on any and all aspects of a “project.” Common metrics, vocabularies, forms and other such data facilitates review, approval and management from all corporate functions. Hierarchical access to current stored information and condensed summaries allows timely decisions by upper corporate management. The present system facilitates analyses at detailed levels, or at overall levels, and includes comparisons to past projects and for collecting cumulative information that measure the overall impact of the projects past and present.

### CROSS-REFERENCE TO RELATED APPLICATIONS

The present application claims the benefit of U.S. Provisional Patent Application Ser. No. 60/648,499, which was filed on Jan. 31, 2005, by the same inventors bearing the same title, and the provisional application is hereby incorporated herein by reference.

### BACKGROUND OF THE INVENTION

1. Field of the Invention

The present invention relates to systems for controlling and monitoring the decisions and implementation of new products, processes or procedures from an initial idea or concept to the end of life.

2. Background Information

Virtually every business or endeavor that produces some goods and/or services employs a system to control and/or monitor the development and/or the process by which those goods and/or services are provided. Many companies have commercial software products that are designed to meet this need, and many of those products have been patented.

The term “project” is used herein inclusively to refer to tasks and components, products and processes associated with the acceptance, development and commercialization of any new product, process or procedure or combinations thereof, either for internal or external use, that encompasses and facilitates the management of the project from its beginning to its end of life. The term “product” will be used inclusively to refer to the end result of a project, and that may be a physical “product” or a process. However, where context dictates, for example, when describing a prior art process the word “process” may be used.

One U.S. patent office publication number U.S. 2003/0033191 A1, is representative of the prior art. This publication includes “systems and components [that] facilitate new product development and product lifecycle management.” The publication contains fifty figures illustrating the forms and requirements that implement the substance of this publication. This publication details six major time sequential steps in its “lifecycle” approach. Those steps are organized around an interactive communications network designed to allow tracking of progress and status in the development tasks. The steps are: Justification; Requirement Analyses; Development; Verification; Launch; and Retirement. Each step comprises documents, plans, reviews, and tracking capabilities, and the entire system describes “Business Objects” that are vehicles or unifying structures that represent major components within the lifecycle steps detailed above.

In addition, there are many references found in the various available data bases that disclose many forms of “new product processes.” These examples of prior art typically begin at the justification of a project and end when the product is released to sales and service. They do not end with the end of the product's life. Moreover, there is little or no information available at the end of a product's life and little or no data available for review and/or analyses.

In each of the prior art references, broad encompassing structures and goals are stated, but, in fact, the broad structures and goals are limited. For example, as projects travel through a corporation on their way to being commercialized, problems abound. For example, R&D, Sales, Service and Marketing are driven by differing goals. Since these functions use different terms and measurements (metrics) for their successes and failures, misunderstandings occur. The different functions within organizations retain exclusively much of the business and technical data and information associated with the functions as they contribute to a project. When such information is unavailable, the organization as a whole cannot easily learn from the past successes and failures. Instead, there is inevitable confusion, finger pointing and roadblocks. Information allowing early decisions, especially decisions to halt a project, from across company functional boundaries, using up-to-date prioritized data and progress, may not be available to the proper deciding entity. Information, in the broadest sense (physical data, analyses, reports, critiques, etc.), from the very beginning to the end of the product or process life cycle, is piecemeal, distributed over an organization's functions, and so is neither readily available nor in efficient form. The ability to learn from the past is compromised, as is prioritized reviews. Analyses of projects, after they have been obsoleted, are ignored. Automated flagging and integration/cooperation across a company's functional boundaries are lacking.

### SUMMARY OF THE INVENTION

The present invention addresses the limitations of the prior art while processes and apparatus embodiments of the invention are directed to achieving advantages for the organization including those cited above.

The present invention provides an on-line computerized process having an application protocol for managing a project from a computer system over a computer network using a transport protocol, the process includes: requesting, justifying and defining a new project; developing and tracking of business and technical milestones; flagging and monitoring of business and technical milestones; computing costs, timing and other relevant items with respect to the project including the finished product or process; entering actual data and other information as it becomes available; creating thresholds for any or all of the flagged items; determining persons and times for reviewing and approving the project; wherein the persons are selected from across the companies functional groups, and storing all the data, projections and actuals, comparisons, descriptions, analyses and other relevant information in a central storage facility, wherein all such contents of the central storage facility share common metrics, common vocabularies, and wherein all such relevant information is readable, and further where all such relevant information is accessible according to a hierarchical order.

The present invention also provides a system that implements the preceding processes as well as additional functions as described in the claims and the preferred embodiments.

The present invention provides advantages to users by providing an open strategy system with tools to comprehensively assess, manage, and control projects from the idea to the end of product life, and to further be able to compare past and present projects with respect to many different metrics in order to learn and improve the company's performance and decision making. The present invention provides for retaining past and present business and technical data in a central depository using standard metrics and a common vocabulary that facilitates comparisons among present and past projects. The present invention facilitates: identification of projects that are likely “winners” and those that are likely “losers”; identification of accountability for successes and failures; streamlining of the new project process and easing of implementation of best industry practices. The status of a project from the start to the end of the product's life is made available to all corporate functions and divisions, as well as corporate management, so that timely decisions can be made. The present invention is directed to ease cooperation among corporate functions, while promoting innovating thinking from all parts of a corporation.

The present invention comprehensively organizes, monitors and allows control of a project from conception to the end-of-life (EOL) of any product or process. The present invention provides for better informed, timely decisions where projects with better returns are selected and poor performers rejected. The use of standard vocabularies, metrics and business methodology provide for consistent and understandable information that transcends corporate structures and functions. One feature of the present invention provides for automatic flagging when “at risk” thresholds are violated (some parameters may be exceeded, some not reached) or where “hurdles” that must be overcome are not. Actual costs, timing, resources and other such facets of projects are tracked against projected values and past information on other projects and their supporting information can be retrieved and compared.

The present invention provides means for tracking and managing no any project. Projects are requested and approved. Further approvals are usually sought at the start of design and development, before manufacturing, and then again upon release for commercialization (sales/service). The status of the project is available for review at any point during a project's life. This review may be restricted to high level management, but other arrangements for company wide review may be arranged. Projected information and actual information, as it accrues, may be compared and analyzed. Moreover, projects which are deficient in some area may be flagged and scrutinized more closely. Specific metrics are arranged with thresholds designated, e.g., unit sales cost or percent of market, etc. When a threshold is violated, automatic notification may be sent to senior management and/or to those responsible for the project.

In particular, the present invention comprehensively collects and provides information in a systematic manner throughout the life of the project until the resulting product or process is longer produced. The invention provides means for integrating complementary plans and documentation from other company functions e.g., sales and marketing, manufacturing, service, etc., and making them available with other data in a comprehensive data warehouse. Software is provided for extracting, tracking and comparing such data and information.

A new product request (NPR) is developed that may be based on an analysis of a DW (Design Win). Herein DW shall refer to one or both of two forms, unless context indicates differently. One form is for tracking a design that will win against competition and a second for designating competitive opportunities as they occur. DW's are usually developed from sales leads that identify designs that will have an enhanced competitive edge or applications where the design will be especially effective. The present invention allows a project's progress to be compared to the competitive opportunities as they evolve. Contrasts and comparisons may be made therefrom, since the information is stored using common forms, terms and metrics and is available from a central data warehouse. In particular an ante-mortem may be used a s “look ahead” of potential success of failure. An ante-mortem may be arranged to compare the projects progress to evolving business conditions, for example via a recent DW. As discussed later, a project's status, data and information will be available via a web page, although access may be structured in a hierarchical manner.

An NPR may be generated from virtually any person. The NPR is reviewed, and if approved, a Product Requirement Specification (PRS), a Marketing Plan, a Development Plan and a BC (Business Case), that includes full financial analyses and launching requirements, etc., are generated and reviewed. If approved, the design and development (“R&D” and “design and development” are commonly understood terms and are used interchangeably herein) of the project advances in an iterative process common to design and development stages. During this part of a project, the responsible design and developments group will often employ a program for tracking a project, herein referred to as “DCPT”. This program contains cost and timing information and thresholds that, when exceeded, will generate e-mails automatically or other flagging techniques to notify management of issues that may exist within the project. The present invention provides for incorporation of the DCPT or attaching it to the present invention. Although a DCPT may be generated in the R&D group, the data may be part of the present invention in the case where the R&D group does not provide the DCPT.

After review, if the project emerges as viable, it is released for production (sometimes referred to as manufacturing or fabrication). After release, bookings, billings, and backlog (BBB) may be gathered as well as competitive wins and input into the inventive system. At the end of the project's life, e.g. when a product becomes obsolete or a process superseded, ante-mortem and post-mortem analyses may be generated for future use, although the ante-mortem may be generated much earlier in the project cycle. Generally, such ante and post mortems are flexible in their contents. The ante-mortem will generally list the assumptions, goals, returns, resources required, etc., and keys to success prior to the project acceptance. As mentioned above, the ante-mortem may be sued to compare the present situation-of a project with the evolving business conditions and competitive posture. Conversely, the post-mortem compares what actually occurred with an affirmation of “what went right” and “what went wrong” in the project.

At any time when reviews result in a marginal approval, projects may be placed in an “at risk” status that may heighten the review processes and trigger additional notification to managers, etc. As discussed below, different managerial levels will have hierarchical access to the data warehouse and similar personnel will make up the review Teams that will pass on the project from time to time.

One aspect of the present invention entails use of a central data warehouse repository of all the data and information associated with a project. This data is made available throughout the corporation using the present invention, and information is entered and updated from the time of the NPR to the post-mortem generation. An advantage of the present invention is that the information stored in the central data warehouse is organized using (at least) standard attributes, forms, documents, analyses and checklists. Moreover, standard metrics and vocabularies are employed for clarity among the users from any corporate functions. Documents sourced from other corporate divisions or groups may be attached and stored for viewing by users. Interface links are provided, as known in the art, to communicate with the various corporate functions interested in the projects.

The system software, in a preferred embodiment, is written in Java, but those skilled in the art will understand many other languages, and/or firmware and hardware modules may be employed to achieve satisfactory results.

The present invention provides:
a) An interface for creating, editing, viewing, listing and approving NPR's and for approving projects therefrom;
b) A mechanism for enforcing the approval at least for the development and later the release of the project;
c) An interface for creating, editing and viewing the plans associated with a project, for example: Marketing, Development, Distributor, Sampling/Inventory, Customer Penetration, Production, and End-Of-Life Plans;
d) Checklists of tasks, issues, goals for completion before approvals, and/or risk analysis, where all analyses are presented in tabular an graphical forms;
e) A mechanism for interrogating and bi-directional linking to other corporate systems wherein documents in those systems identified with a project may be attached to the project;
f) Financial analyses for calculating and displaying the financial profile during a projects life, e.g., cash flow, ROI (return on investment), and expense data;
g) Operations modules and Interfaces for comparing financial data, e.g. projections to actuals; projections and/or actuals to product-line history, and corporate and division history; projections and/or actuals to similar projects; and projections and/or actuals to hurdles or level criteria previously established for the product-line, corporation and/or division;
h) Interfaces for creating, editing and viewing the timeline of a project, specifically at least an NPR submissions and acceptance, project start, development and release authorizations;
i). Interfaces for comparing timelines during a project, projections to actuals, projections and/or actuals to corporate, divisional and Product Line historical data, and projections and/or actuals to hurdles or level criteria previously established for the product-line, corporation and/or division;
j) Mechanisms to identify projects that have failed to meet designated financial, timeline, resources or other criteria, and where such projects are declared “At Risk,” mechanism to send e-mail or other such alerts to management or other designated persons;
k) Interfacing to and incorporation of modules from various parts of the corporation including costs and tracking programs, and automatic updating from these modules;
l) A hierarchical login of personnel authorized to view and edit the information regarding a project;
m) A common data format that is understandable over various reports/form, etc.;
n) Identifiers that are unique to each project and to other systems, such as design/development, sales, finance, etc.;
o) A central data storage facility for storing all the information concerning a project and providing authorized access to the data; and
p) Modules for summing the information, largely from the central data storage facility, over all or many projects so that the total business, including R&D spending, products in the pipeline, the actual sales volumes and similar data is available to allow a company, division or Product Line to better manage its business.

It will be appreciated by those skilled in the art that although the following Detailed Description will proceed with reference being made to illustrative embodiments, the drawings, and methods of use, the present invention is not intended to be limited to these embodiments and methods of use. Rather, the present invention is of broad scope and is intended to be defined as only set forth in the accompanying claims.

### BRIEF DESCRIPTION OF THE DRAWINGS

The invention description below refers to the accompanying drawings, of which:

FIG. 1A is a block diagram example of a computer communications system that embodies an example of the present invention,

FIG. 1B is a organizational block diagram illustrating corporate functions interfacing with an example of the present invention;

FIG. 2A is a time/function block diagram sequence diagram of an embodiment of the present invention as applied to a project;

FIG. 2B is a chart of types of components containing information and/or data available from the data warehouse;

FIG. 3A is an illustration of a procedure associated with a NPR and a design win (DW) input;

FIG. 3B is a listing of information fields of an NPR example;

FIG. 4 is a time chart illustrating typical design/development steps;

FIG. 5 is a sample one sheet Executive summary from a BC;

FIG. 6 is a detail of the Sensitivity Analysis from the Executive Summary;

FIG. 7 illustrates RISK ASSESSMENT topics from the Executive Summary of a business case (BC);

FIG. 8 is an example of Financial Projections from a BC;

FIG. 9 is a block diagram illustrating a Launch Plan,

FIG. 10 is a block diagram illustrating examples of Sampling, Inventory, and Distributor Stocking Plans;

FIG. 11 is a chart illustrating examples of personnel actively (actor) involved with projects and their functions;

FIG. 12 is a table associating users with NPR's;

FIG. 13 is a table of preferred parameters associated with projects;

FIG. 14 is a listing of preferred metrics that are commonly used;

FIG. 15 is a block diagram illustrating hierarchical access to the information; and

FIG. 16 is a sample common vocabulary that may be used with an example of the present invention.

### DESCRIPTION OF AN ILLUSTRATIVE EMBODIMENT

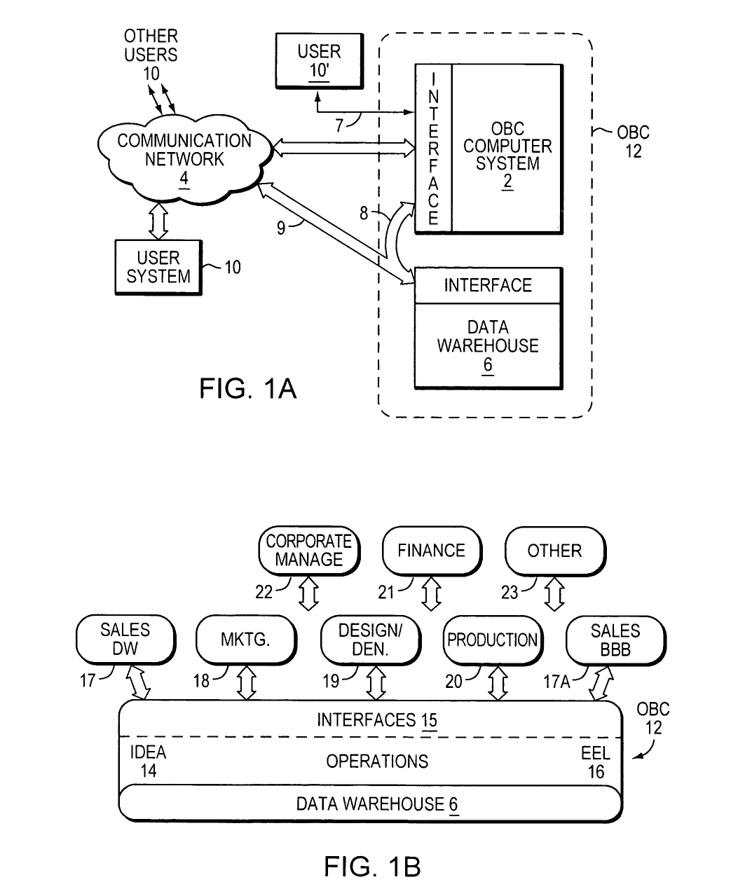

FIG. 1A is system hardware block diagram of a system that may embody the present invention. Practitioners in the art will understand that portions of the present invention may incorporate hardware and firmware/software, and that the dividing line between the two may vary significantly from mostly hardware to mostly software. Also, even though the implementation is described as “on-line” via a communications network or networks, local area or limited access networks or community-type arrangements may be used throughout as may be determined by the users of the system. Practitioners will also understand that a software implementation may be concentrated in a computer system or may be distributed among an array of computer systems, and that those systems may communicate with each other via common buses or via the communications network 4 or other local and/or private networks. Moreover, the central depository, or data warehouse, may be directly connected 8 to the server or connected 9 to the network 4, and it may be similarly distributed. User terminals 10 will generally access the server via a communication network, e.g. the Internet, but the telephone network or other private networks and/or other local networks may be employed in different embodiments. The user will generally do so via a computer system that functions, inter alia, as a terminal 10 to the network 4. However, user hardware/software may be found in large computing system or small terminal, or in hand held portable (wireless) devices. In some embodiments, the invention may be arranged in a Client-Server 2 configuration where a user 10′ may be directly connected to the OBC Server 2 and act as a local terminal. In the preferred embodiment of FIG. 1A, the OBC Server 2 and the Data Warehouse 6 are marked as OBC item 12 (On-line Business Case), and they comprise major components of an embodiment of the present invention.

As known to those skilled in the art, the software modules that may include “objects” that control the communications between the blocks in FIG. 1A may be resident within those same blocks, but the software may be distributed within interfaces separate from the blocks in FIG. 1A.

FIG. 1B is a system block diagram illustrating the corporate interaction with the present invention. Typically, these interactions will be from software modules and programs resident within the corporate structures illustrated. Since there are many programs available, any document resident on another server or system can be converted to be at least readable on a presentation display from the OBC 12 (On-line Business Case) is an example of a preferred embodiment of the present invention. Typically, the OBC 12 is a combination of hardware and software modules functioning, as described herein, in preferred embodiments. The OBC functions as a central logical location wherein virtually all corporate functions may interact on any particular project from the idea 14 to the end of life 16. The interfaces 15 allow the OBC to communicate with at least those functions shown: Sales 18, Marketing 20, Design and Development 22, Production 24, and Finance 26, and Corporate Management 28. Other functions 23 might include Service and Quality Assurance.

In each case, the corporate functions exist on other computing systems, and the interfaces 15 will typically accommodate a local network within the corporation. The use of compatible software modules, since conversion utilities are commonplace, is fostered throughout the organizations, as is the use of common metrics and vocabularies that assist in making the information among the different functions more understandable. Moreover, any information extracted from the other systems will be at least readable by a human. Promotion of such compatible features across corporate functional lines is to be fostered.

The OBC 12 runs from the “idea” 14 to the obsoleting 16 of the new product or process. As evident from FIG. 1B, Sales 17 is often the source of the idea and the resulting product's commercialization 17A. Marketing 18, Design/Development 19, Production (Manufacturing) 20, Finance 21 and Corporate Management 22 are closely involved. In some preferred embodiments, Service/Quality Assurance 23 may be involved.

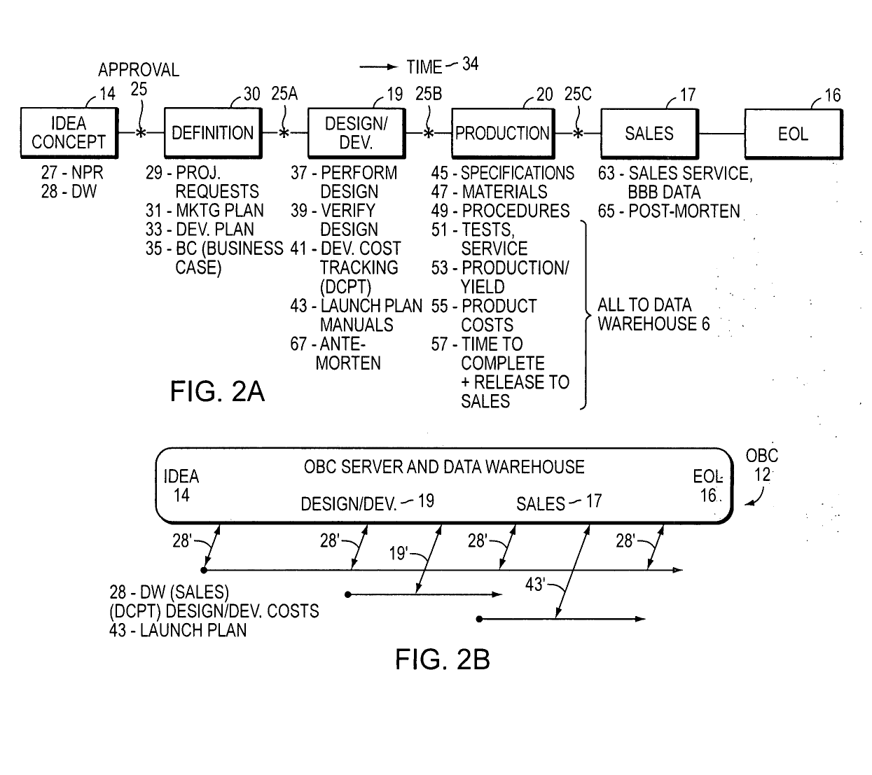

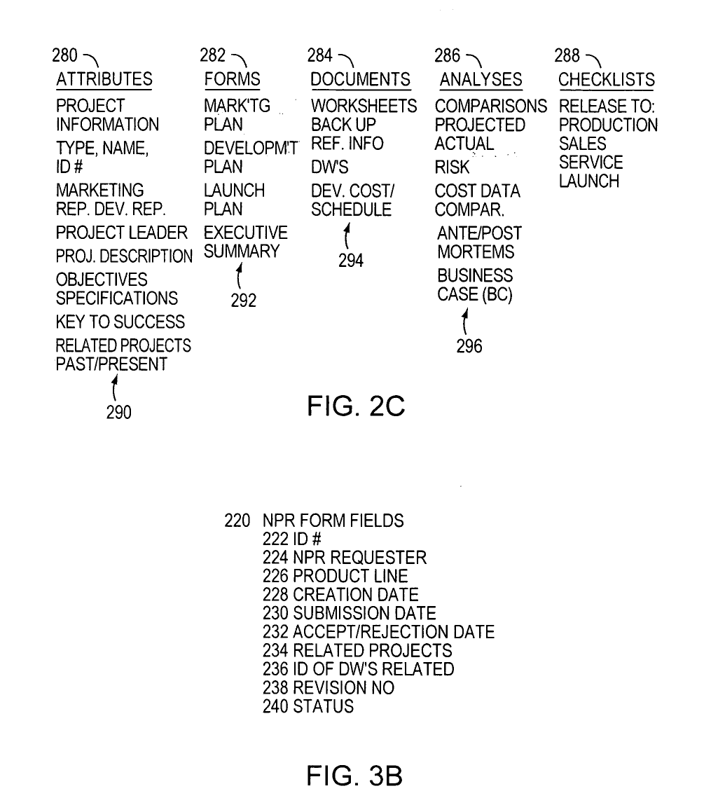

FIG. 2A is a more detailed block diagram over time 25 of a project's life cycle from an idea or concept 14 to its end-of-life 16. The idea 14 may emanate from virtually any source, often from marketing or sales, but indirectly the source may be from customers, service personnel, designers/engineers, etc. A New Product Request (NPR) 28 is IS generated, often from a supporting Design Win (DW) document (or documents) 28. The DW identifies and tracks opportunities that the NPR will generally attack. The NPR is submitted, generally, to the marketing or Product Line manager or group for approval 25. If approved, the project enters the Definition stage 30, and, if again approved 25A, the Design/Development stage 32. If the project is again approved 25B, the project then enters production (manufacturing) 34 and, if again approved 25C, the project is release for sales (commercialization) 36. Usually, at some later time, the product result of the project is obsoleted 22. During the entire process, all the project and actual, as they become available, information: data, plans, forms, comments, evaluations, costs, timing, reports, etc., are stored 40 in the data warehouse 6 (FIG. 1A) for inspection and analyses. In particular, the inspection and analyses include, as discussed below, comparing projected and actual data; automatically generating and distributing alerts that identify risks and trouble projects; assisting in strategy development; and generating ante-mortem and post mortem analyses, and historical comparisons.

FIG. 2A illustrates a time line task oriented picture of a project's progress from beginning to end. Although not detailed, each block and each form, document, analyses, etc., depicted within FIG. 2A inherently includes the software/hardware necessary to accomplish the “tasks.” That includes presentation displays and presentation hardware and software, creation and editing hardware and software and the accessories and accompanying software to printout, transfer, communicate, and manipulate the data and information as described herein. Such capabilities are known to those skilled in the art, and any hardware, software, accessory, utility, etc., needed to enable and/or accomplish any task, function or feature described and/or claimed herein is included within the blocks and descriptions, although not specifically mentioned.

FIG. 2B illustrates an assimilation of externally generated documents and the ability to track various parameters of a project. In the case illustrated, a DW is generated within Sales 17. A link between Sales and the OBC 28′ allows data to be passed therebetween. This interchange of data will typically occur at set points 28′ along the time line of a project. The OBC will allow the DW document itself to be attached to the project and stored within the Data Warehouse for present and future use. In a similar fashion, if the Design/Development group 19 provides a cost/time schedule (see DCPT), it is linked 19′ to the OBC and data interchanged. The Launch Plan 43 may usually be generated within the OBC, but if generated externally, it will be linked to the OBC with the ability to interchange 43′ data. In most cases, the OBC will inform the sales group via DW and the Design/Development group when and if the project is canceled.

Data Warehouse

FIG. 2A illustrates several features of the present invention. One such feature is the use of a central data depository—a Data Warehouse. The Data Warehouse contains all the information generated for and during the project's lifetime through its end of life EOL. In particular, externally generated DW 28 and DCPT 41 documents are attached to the OBC, and all the information regarding project tracking, along with the approvals, are easily accessed by those concerned with a project to allow for better and more timely decisions. As mentioned above, common vocabularies, common metrics and common forms facilitate ease of understanding and comparing.

The present invention provides, in a preferred embodiment, several mechanisms for finding a particular NPR. Those mechanisms include a list of all NPR's, all active NPR's, an NPR search engine, specific links to an individual with authorization, links to related projects and other related information, e.g., DW's.

In an embodiment, the list of NPR's will include the unique NPR ID number, the creator of the NPR, the current status, the Product Line and/or part no., and links to project detail screens.

The search engine is designed to allow users to choose values for one or more attributes and display the NPR's matching those values. Sub-string text searching, dates, date range and exact matching of other fields are supported. The results of any search will be in the form as described above.

When a NPR has been found, in one example of the present invention, the following details will be displayed:
a) The current status;
b) The person currently responsible for handling the NPR (the NPR requester, the person submitting the NPR to the next function, or the NPR reviewer);
c) The contents of the NPR (up-to-date, when the NPR was submitted, and when the NPR was accepted or rejected);
d) If the NPR was accepted, the project name, and ID, the project status and links to the project's details screen;
e) The history of the NPR (the who, what and when concerning the NPR for each of the creation, submission, dispatching, and acceptance/rejection of the NPR; and
f) The deletion/purging of the NPR may be programmed for, preferably one year after rejection or upon action by the requester or a dispatcher.

FIG. 2A illustrates the organizational information modules used in a project life cycle for tracking, evaluating and controlling the product lifecycle. The collected information regarding a project is broken into five standard groupings of information modules. The five are: attributes 50, forms 52, documents 54, analyses 56 and checklists 58.

FIG. 2C further illustrates information available in the five standard groupings. Attributes 280 contain fields 160 that fully identify the project, its leaders, and its status, etc. Forms 282 are structured modules that contain and store project data. The data is entered, reported and manipulated by traditional known software techniques. A Development Plan, marketing plan, launch plan, product specifications, etc., are typical “forms” 292. Documents 284 are electronic files in virtually any format that contain material information about a development effort in a project. Worksheets and backup information 294 fit into this category. Analyses 286 are specialized reports for a given project. They may be based on available information stored in the data warehouse, including historical information. Examples include the business case, comparisons of projected and actual, at risk reports 296, etc. Checklists 288 include relevant listings of items necessary for some function and sign-off lists that ensure the entire corporation's cooperation and agreement on the relevant stages of the project.

NPR

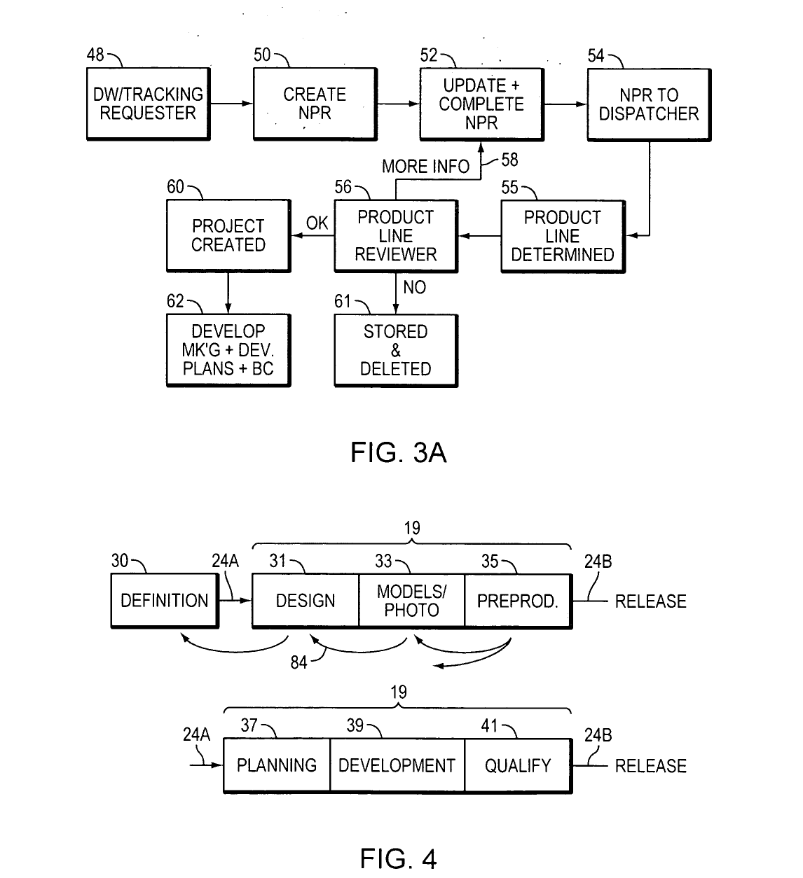

FIG. 3A is a detailed state/flow chart illustrating the task flow of getting from the NPR to the start of a Project. An idea or an opportunity is uncovered where any corporate employee may create an NPR 50. In practice, an NPR is often generated from a DW 28 opportunity that may have to be modified. NPR creation software module may be accessed to accommodate virtually any DW. The ID of the new NPR Form and the ID of the DW's are entered into both the NPR form and the DW documents. In a preferred embodiment, an NPR Form is available on a secure web site where information described herein is entered 52 and the status set to “NEW.” Once completed the NPR is submitted 54 to a dispatcher who determines the appropriate Product Line 55 and sends it to the NPR reviewer 56. The reviewer can reject the NPR or ask for more information 58. The reviewer then considers the NPR and either rejects it 61 or approves it 62. If approved, a Project Team 60 is created and it, in turn, creates the Marketing and Development forms and the BC. If rejected, the information accumulated may be stored and/or deleted 58.

FIG. 3B is an example of data fields 220 in an NPR form. The fields include: a unique ID number 222 that identifies this particular NPR; the name and full contact information of the requester 224; the Product Line affected 226; the NPR creation date 228, the date 230 the NPR was submitted for approval; the date 232 of acceptance or rejection; identified related projects 234; related DW opportunities or design opportunities 236; a revision number 238 to keep track of updates to the form; and the status 240 of the request. For example, the status 240 may include, if this particular request was approved, what Product Line of function within the corporation is to (or should) be responsible for the project; generic specifications; key technologies; a prospective release date; a market analysis with prospective target penetration/prices; and competitors, marketing strategies and any other relevant information/comments.

Referring back to FIG. 2A, in the Definition stage 30, an initial project Team is assembled across functional lines to draft, at least, a) project requirements specification 29, b) Marketing Plan 31, c) a Design/Development Plan 33, and d) a BC 35 (Business Case). The BC includes 1) an executive summary, 2) a market environment abstract, 3) a strategy and positioning summary, 4) financial projections, 5) an Implementation Summary, and 6) any relevant supporting material. Typically, the marketing representative on the project Team will generate and complete the Marketing Plan. Similarly, the Development Plan will be completed by the development person. The project requirements specification and the BC will be completed by the project Team, in most instances. In some preferred embodiments, a production person may be part of the project Team and a Production Plan may be created.

Still referring to FIG. 2B, if approved 25A, the project enters the Design/Development stage 32. The Design/Development stage 32 is dependent upon the specific project, but all such plans include iterative tasks 84 that result in a timely prototype, model or program that is qualified or verified to ensure that it meets its intended specification, cost and reliability standards. An example of Design/Development tasks that might be associated with a product is shown in FIG. 4 and includes (after having approval 25A of the project after the design definition stage 30), a design stage 31, a prototype/evaluation stage 33, and a pre-production stage 35. After approval 25B, the product is released to Production 34. Another example of tasks involved with a process might include a planning stage 37, a development stage 39 and a qualification stage 41. After approval 25B, the process is released. A characteristic of the tasks performed in the design and development are typically iterative 84 as problems arise and detailed reviews are required before each portion is deemed completed. As shown, the iterations direct attention back to earlier stages.

Still referring to FIG. 2A, a design and development group is selected to design the product 37 (or process) and verify 39 that the product meets the required product specifications and the projected product cost goals. The actual development costs and development milestones are tracked 41. At this time, a launch Plan 43 may be developed.

The Production Phase 34 of FIG. 2A is similarly dependent on the specific project. Final specifications 45, fabrication, assembly, test documentation, data sheets, and testing, etc., 47, 49, 51, associated with virtually any manufacturing process, are accomplished during this phase. During this phase, the time to complete and release the project to sales 57, and the determination of unit standard and variable costs 55 are determined. At this time, there is comparison to the earlier projected costs (and other metrics) for the project. When the project is approved, it is released 25C to sales 61 (commercialization). During the Sales phase 61, information of Bookings, Billings and Backlogs 63 (BBB) are made available from Sales or Finance as Documents for comparison to projections as well as comparisons to other projects. Finally, the EOL 22 is reached where a Post Mortem 65 and an Ante-mortem 67 (this may be compiled earlier) of the project may be compiled for comparison purposes.

Business Case (BC)

The BC 35 is a core of preferred embodiments of the present invention. The BC provides the ability to compare projected to actual information and to provide that comparison to the responsible persons so that informed, timely judgments regarding a project may be made.

BC's are structured with a common format. Typically, a word processor is all that is necessary to view and/or edit a BC. Of course other software modules and functions may be used consistent with the word processor and the BC. Each portion of a BC is generated by the specialist assigned the task.

In particular, comparisons between projections and the actuals are provided. Specifically, the following comparisons may be provided: profit margins, timelines (with highlighted failures), Market/Sales metrics, Development metrics, the number of iterations with respect to the projects, unusual happenings during the project (stops/restarts/re-authorizations, etc.), and projected versus actual customers.

FIG. 2A shows the creation of the BC 35 during the Definition stage 30 of a project's lifetime. The BC includes, in a preferred embodiment, 1) an Executive Summary, 2) a market environment, 3) a strategy and positioning summary, 4) financial projections, 5) an Implementation Summary, and 6) any relevant supporting material. The Executive Summary is especially useful to corporate management as it provides up-to-date, succinct views of any project, including those “At Risk” that may need further scrutiny.

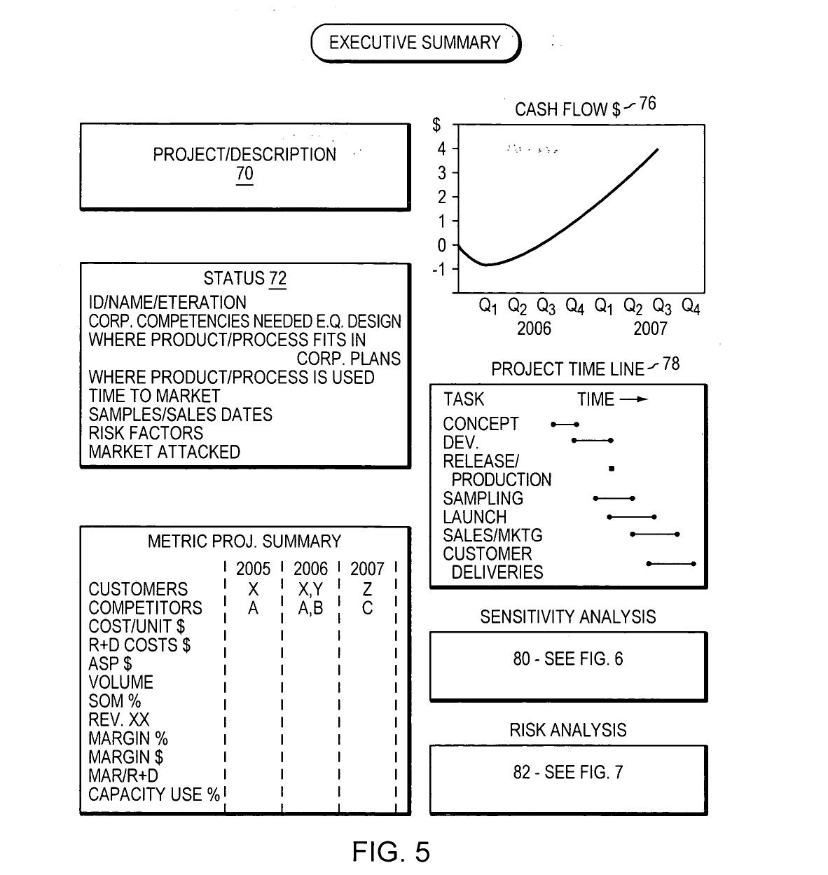

The BC Executive Summary is a one page tool through which a succinct view of the project can be had. FIG. 5 illustrates an example of an executive summary page. There is a brief narrative description 70 of the project drawn largely from the marketing plan. The description might indicate where the resulting product, system or process applies, its potential customers, where it is produced, where tested, and how it fits in with other products. The project situation/status 72 would identify the project by name, its end user application and/or customer, its competitive position (for example as a primary or second source component), the dates for introduction to the market and risk factors (for example competitors' market penetration). The three year forecast 74 may include actual and prospective customers, competitors, unit cost, design/development costs, projected sales price, projected sales volume, market share, total revenue, gross margin, capacity utilization, and other financial indicators that may be relevant to the assessment of the project. The cumulative cash flow graph 76 may include an illustration of where the project pays for its initial costs. The project timeline 78 includes the concept date, the start of development, the date of release to manufacturing, sampling, sales/marketing launch, and the date of delivery to customers. The timeline 79 may include critical dates identified by prospective customers. The Sensitivity Analysis 80 is an illustration of the impact on the forecast cumulative cash flow as metric, discussed below, and varies from the initial assumptions. The Risk Assessment 82 lists risk criteria identified with a specific project. For example, the risks may include the number of competitors, gross profit margins, any earlier failures for the project, use of outside contractors, manufacturing capacity used, and the track record of projects released using similar corporate functions. In the OBC, presenting any field of any document, critical projects or issues or thresholds that have not been met, may be highlighted.

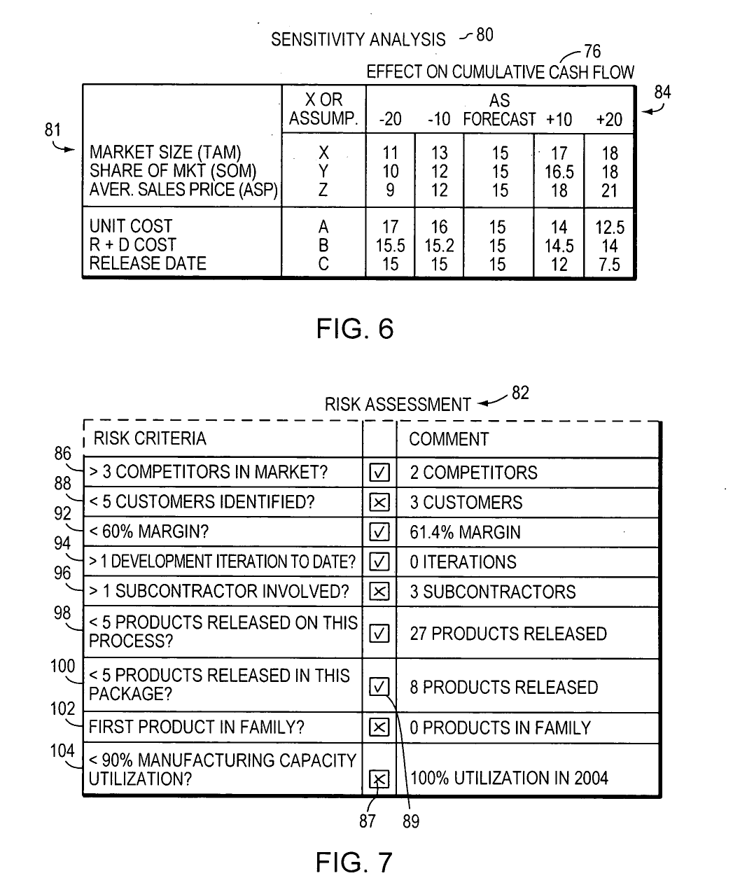

The contents of an Executive summary are flexible but, for the most part, understood by the above descriptions. The Sensitivity Analysis 70 may require further discussion. FIG. 6 illustrates a Sensitivity Analysis Chart 70. The metrics 72 used in this chart are the market size TAM, the share of market SOH, the average selling price ASP, the unit cost, the design and development cost (R&D), the proposed release date (or any other critical date). The chart illustrates the impact and leverage on the cumulative cash flow 66 by missing the initial assumption amount by the percent indicated 74.

An example of a Risk Assessment 82 is shown in FIG. 6. Here competitors 784 and customers 86 are identified. In the competitors row, the number of competitors, here greater than three, indicate that if more than three are involved, the project's value to the corporation may be lessened. There are only two competitors known, so there the risk is within expectations. In contrast, the number of customers 86 is assessed as a risk if there are less the five. Since only three have been uncovered, the low number of customers indicates there is a heightened risk with respect to this factor.

FIG. 7 is an expanded chart of the Risk Assessment 82 from the Executive Summary. In practice, a flag may be generated here that will result in management being automatically notified that a “Risk Criterion” has been exceeded (note that the risk may append to too low of a number, like too few customers). The middle column 87 indicates when a threshold has (an “x”) or has not 90 (a check) been reached and an unexpected risk has occurred. As discussed above, column 87 for the competitors 86 has a check mark while the column 88 for customers has an “x.”

Still referring to FIG. 7, the gross margin 92 that is projected for the project is a risk factor that goes directly to projected profitability. The risks involved with the remaining rows are fairly straight forward. Risk is increased if: a) the iterations 94 indicate if this is the second, third or more times that the project has been tried, the earlier ones being unsuccessful; b) if more than one subcontractor 96 is involved; c) if the project is a process and if few products 98 have been successfully released; d) if the project is a package 100 and few packages have been released in the package; e) if the project is a product that is the first 102 in a possible family; and f) if the manufacturing capacity 104 is under utilized.

As mentioned before, the BC includes a “Market Environment.” The Market Environment describes the state of the marketplace and the reasons for the project, and may include qualitative prose and specific data fields. For example, the market environment may include: 1) the business needs or technical problems of the customer; 2) characteristics of segments of the market; 3) the shape of the market; 4) competitors; 5) competencies required to meet the market; 6) strategic objectives; and 7) tactical objectives.

The Market Environment items above are understood by those skilled in the art. However, the shape of the market may be detailed further. It may include geographical dependencies, types of customers, channels of how business is accomplished, expected growth, cost pressures, price pressures, etc.

The BC Strategies and Positioning outlines the plan to succeed and consists of qualitative text and specific data fields. This category may include: 1) how the project cooperates and aligns with corporate strategies; 2) what product differentiation is planned for the project; 3) pricing requirements; 4) prospective applications in different geographical regions; 5) promotions needed; 6) corporate positioning, keys to success, required tasks; 7) competitors; and 8) risks.

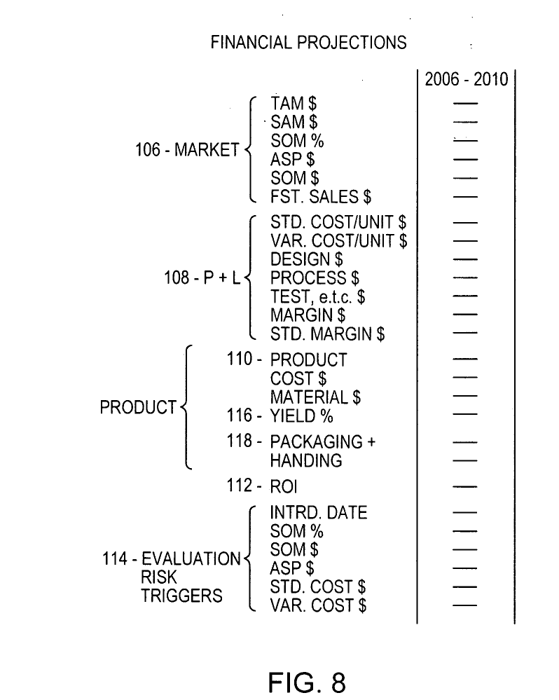

Financial Projections may include a numerical analysis of the project including critical items. For example, these projections would include the design and development (R&D) costs, average selling price, unit cost, margins, revenue and ramp-up plan, the return on investment, and, importantly, re-evaluation triggers or thresholds. The triggers may be determined for specific projects, but, at least, any of the following actual data points may trigger a re-evaluation of the project: 1) any delay (or improvement) in a introduction date; 2) any reduction of market size or a corporation's share of the market; 3) any reduction of the average selling price (say due to competitor activity); and 4) any increase in standard or variable unit costs. FIG. 8 illustrates one such financial projection over five years. The main categories are the size (in dollars) of the Market 106, the P/L (Profit and Loss) 108, the Product Cost of the item 110; Yields and Testing factors 116, ROI 112 .(return on investment); and Triggers 114 that may generate automatic notification for review.

The metrics illustrated for the Market 110 are: TAM (the total market); SAM (the part of the market served by the corporation); SOM (the corporation's share of the market in percent and in dollars); and ASP (the average selling price). The P&L 108 includes the standard and variable costs per unit, the R&D design, process, test and capital costs and the margins in dollars and percentages. The product (if there is a product) cost 110 includes the material and yields after processing; the costs associated with final packaging and handling 118; the ROI 112; and the Triggers 114. The Triggers 114 include, in this example, the introduction dates, the corporation's share of the market, the average selling price and the standard and variable costs. These metrics are well known to those skilled in the art.

A BC Implementation Summary provides a high-level view of how the project goals are to be achieved. The contents here might depend on specific projects, for example, a product may have a launch plan and a distributor stocking plan, whereas a process may include beta test plans, etc. But, an Implementation Summary in a specific embodiment would include the overall project schedule from the Executive Summary, the Development Schedule, the Launch Plan, Sampling/Inventory/Distributor Stocking Plan, the Manufacturing Plan, the Customer Penetration Plan and the EOL (End-Of-Life) Plan.

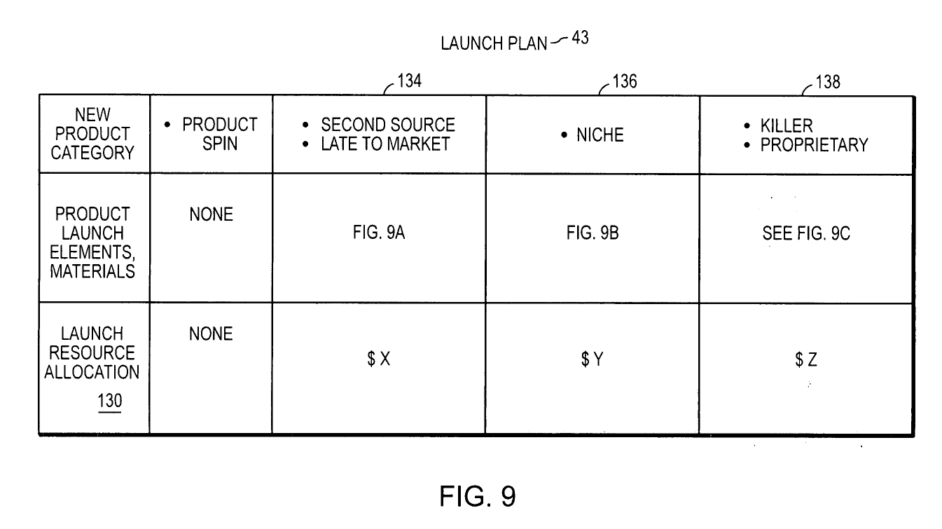

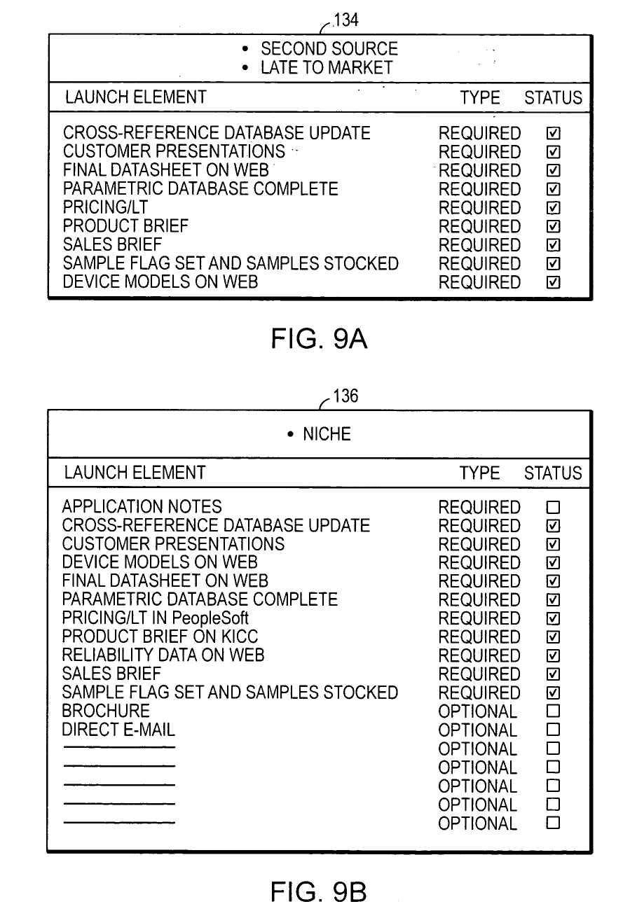

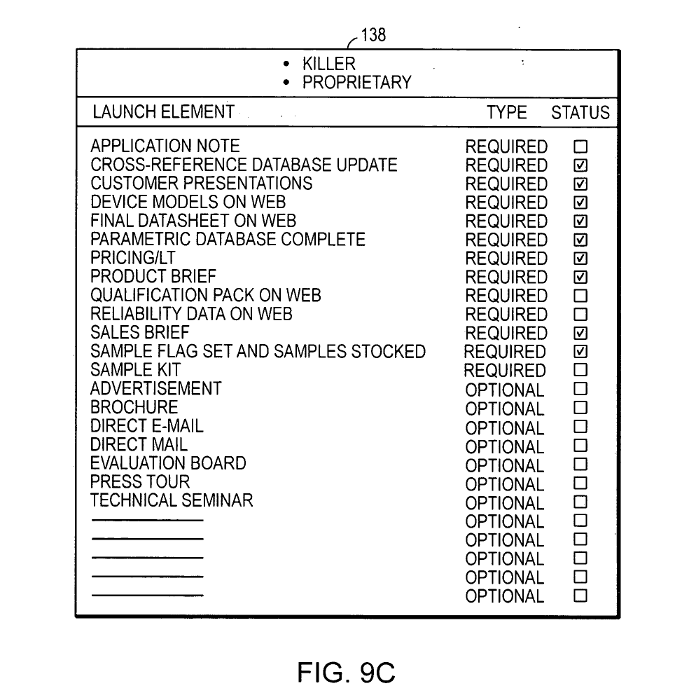

A BC Launch Plan 43 is illustrated in FIG. 9. It details the resources to be applied to the projects, in this case resources 130 are in terms of $ applied to different types 132 of projects. For example, a process that results in a product destined as a second source 134 to some competitors product or a product that is late coming to the market, may only have a minimum set of launching elements, materials and a minimum $X dollar allocation. For example, the launching materials may only include: brief product descriptions, specification/data sheet, customer presentation materials, pricing information, and samples and sales support information and materials. Projects that are destined for some larger, but still limited market 136, may have additional resources and money ($Y) applied to its launch. For example additional materials may include: device models available on the Web site, application notes, reliability data, brochures, direct e-mail may be employed, and all the material may be more extensive. Projects 138 that are proprietary or directed specifically to “kill” the competition or otherwise dominate a large market would have even more money ($Z) and resources applied. For example, the additional materials may include: sample kits, industry advertisements, brochures, direct mail and e-mail, evaluation review, press tour and technical seminars. Generally the larger projects may have twice the resource cost of a niche project and three times that of the second source project.

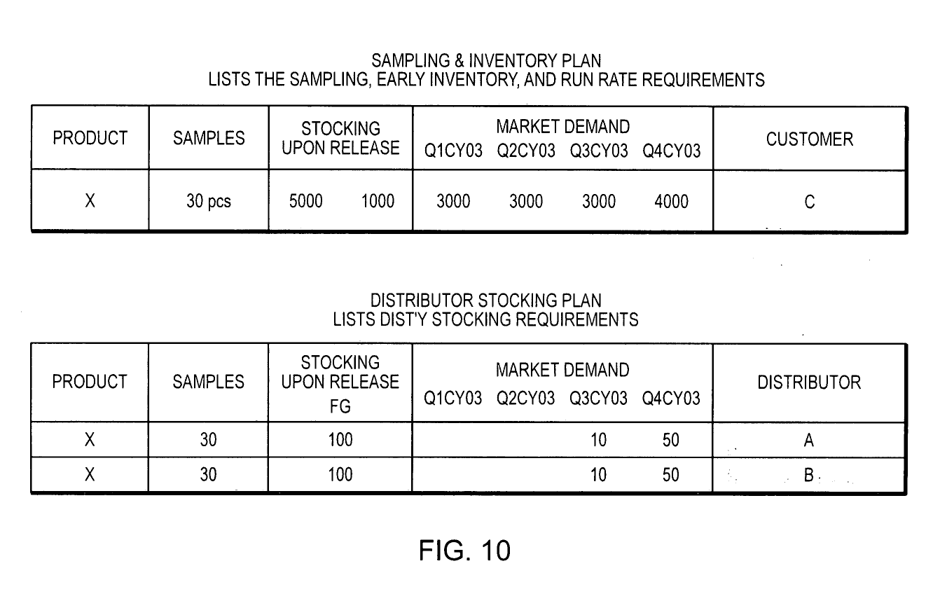

Other BC Implementation Items are found in FIG. 10 and might include sampling, inventory lists and plans, distributor stocking requirements and manufacturing plans that will meet the sampling and distributor needs.

A BC Customer Penetration Plan might include identification of specific customers and determination of products that will win (DW) greater penetration into that customer. Specific products linked to specific customers may be further linked to corporate personnel assigned to those customers. Any critical timing to meet that customer's needs may be included.

An EOL plan may outline the expected life of the project. The plan is typically a spread sheet including part numbers, accounts, applications, quantities, customers, potential other markets that could extend the lifetime, replacement technologies and issues concerned with exiting the “business” associated with the EOL.

Project Participants and their Roles

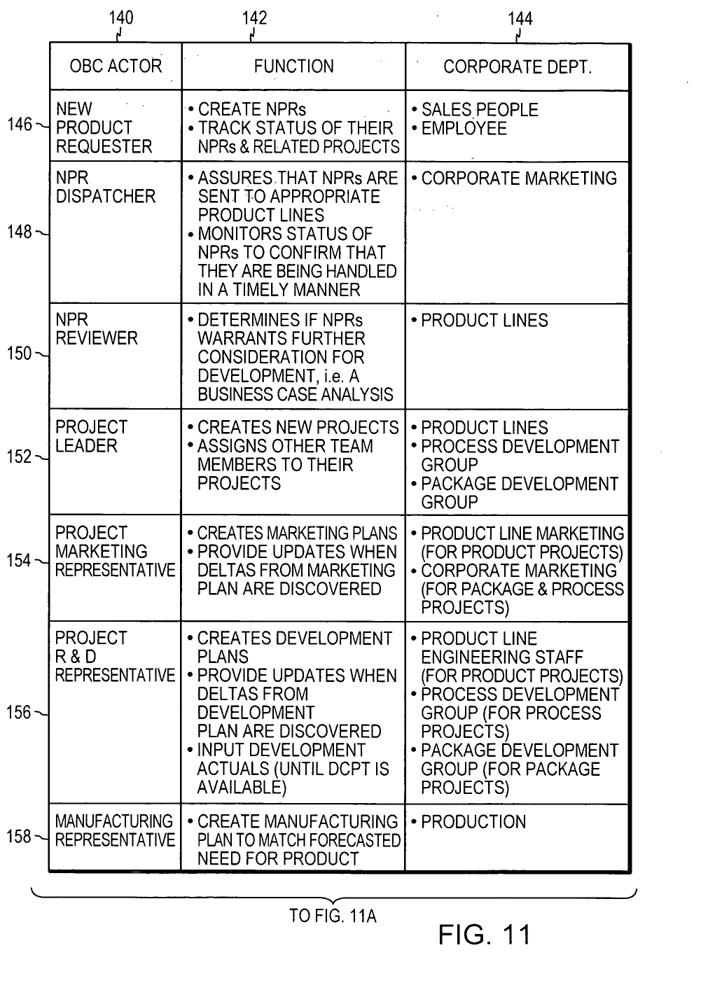

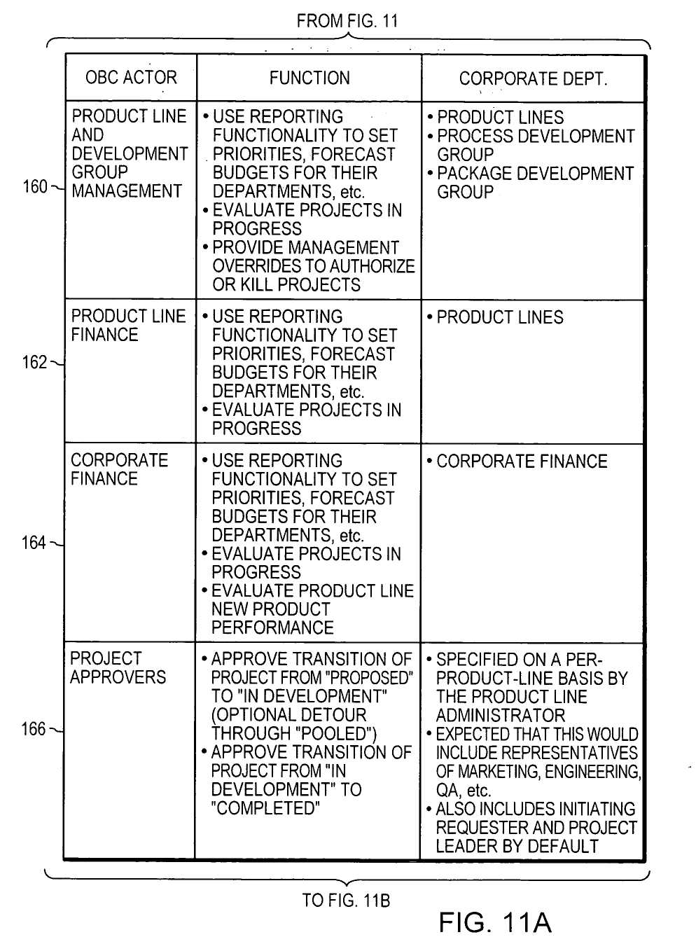

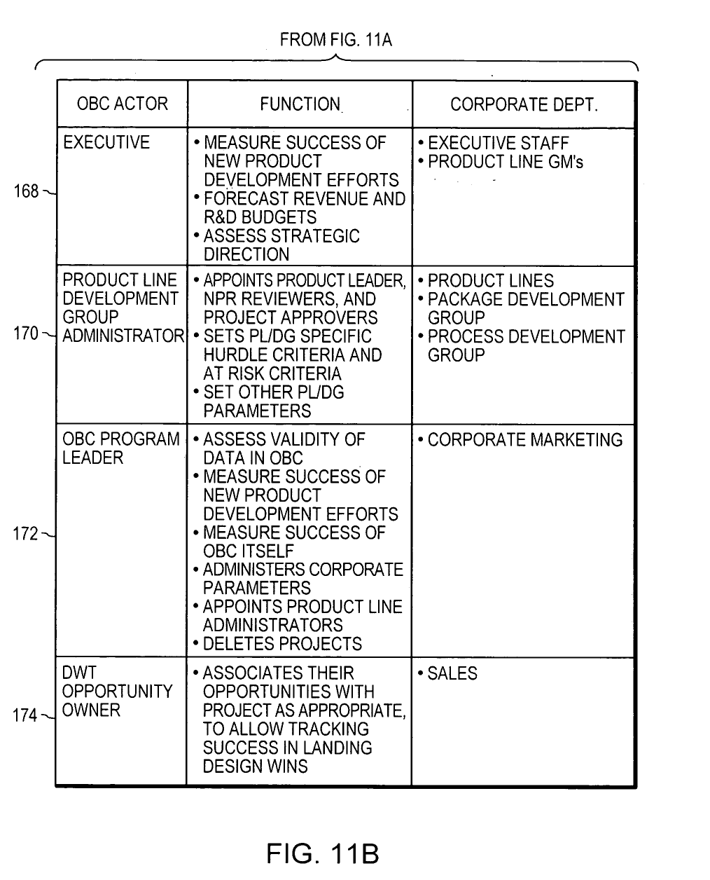

FIG. 11 is a table listing participants in a project as Team members or managers, approvers, etc., 140, what they accomplish 142 using the present invention and the governing corporate department 144. The table is directed toward a project that results in a “product.”

Briefly, the new Product Requester is usually from the sales 144 department, but the requester may be any corporate employee. The requester creates the NPR and can access the Data Warehouse to track his and related or similar projects.

The NPR dispatcher 148 is usually from the Marketing department and ensures that the NPR is sent to the affected Product Line. The dispatcher monitors and confirms that the NPR is being handled in a timely fashion.

The NPR reviewer 150 is from marketing, and the reviewer technically determines if the NPR warrants further action. This reviewer will often be a Team rather than an individual.

The Project Leader 152 is from the design/development group (sometimes referred to as Engineering) and will create the “project” and assign the Team members. The Project Leader will often name the project, generate an ID for the project and provide a short and longer description for the project, together with managing the project in chief.

The Project Marketing Representative 154 is from the marketing function closely affected by the Project. This person will create the Marketing Plan and update that plan as the project moves forward. This person will evaluate the end use application or market, the value proposed and the required time for sampling and release. This person will also generate marketing risk factors, market environment, strategy and positioning, customer and customer profiles, competitors list, selling price, sales volume and share of market, and this person will contribute to financial projections and actual marketing implementation.

The Project R&D Representative 156 is from the design/development function associated with the technical project aspects. This person will generate the Development Plan and update that Plan as the project moves forward. This person will ensure that the core competency needed is met. This person will project time to sampling and will contribute to financial projections and actual development implementation.

The Manufacturing Representative 158 creates the Manufacturing Plan that matches the forecasted need for the product.

The Product Line and Development Group Management Team 160 is formed from personnel from the marketing and development Product Lines closely associated with the product. This Team sets priorities, forecasts budgets and generally evaluates the project's progress. This Team will have the power to “kill” or stop projects or to authorize a project's continuation.

The Product Line Finance person 162 will set priorities, forecast budgets for the related corporate departments and will evaluate a project's progress.

A Corporate Finance person or Team 164 will perform similar tasks as does the Product Line Finance person, except at the corporate level.

Project Approvers 166 are drawn from the Product Line, marketing, quality, and engineering groups. This group will or will not approve the transition of the project from “Proposed” to “In Development” to “Released” to manufacturing, and finally to “Released” to sales.

The “Executive” 168 is drawn from the general managers of the product and/or Product Line and the senior management or executive staff of the corporation. This Team or person measures the success of the development efforts, forecasts revenue and costs and assesses the strategic direction of the project.

The Product Line Development Group Administrator 170 is drawn from the marketing and/or development groups. This person appoints Project Leaders, NPR reviewers and Approvers (mentioned above) and sets “risk” criteria, and specific profit and loss goals (“hurdles”) and other relevant parameters.

A Program Leader 172 from Corporate Marketing assess the validity of the data entered for a project, measures success, administers the corporate rules/parameters, appoints the Administrators and may have the authority to deleted or cancel projects.

Finally, the DW Opportunity Owner 174, usually from Sales, provides continued association of opportunities with the project and tracks success in sales completion “wins” over competitors ear-marked before or during the project.

Marketing Plan

The Marketing Plan is in a Form that contains the assessment of and rationale behind the Project from the sales and marketing perspective. The data in the Marketing Plan is the source of corresponding data in the BC.

Typically, the Marketing Plan will define the primary market segment targeted by the Project, the sub-segment (if applicable), the primary application(s), and any secondary market and/or sub-market segment or secondary application(s). Also, generally there will be a text portion describing ad hoc issues related to the project. This information is generated by the marketing representative on the Project Team.

Generally marketing plans may differ in Projects that will result in a product and those that will result in a process. The Marketing Plan for a product might include a product for external or internal use. The process is typically for internal use, but in some cases the process may be patented and/or licensed.

Consider the Project result is a product or something sold or licensed to customers. In this section, Product will refer to a product or process that may be sold to customers. A Marketing Plan for such a product may include: individual products that may result; target customers and their requirements; number and name and part number (if available) of competitors and their products, competitor technologies; the products competitive advantage, market size, share of market available, and projection of the market share to be won; and selling price, dates of sampling, release and delivery to customers, first year sales volume, and marketing costs. Distributor Stocking Plans may be developed in some Marketing Plans and may include sample quantities and timing of distributions. The actual data, as it accumulates, will be available for comparisons to projected data.

If the Project results in a process, the following may be included in a Marketing Plan: a description of the new process; related products and the Product Lines affected; the site where the process is being developed; related Projects; and whether standard or new development technology is required.

Development Plan—Products

The Development Plan is also a Form that contains projections that includes technical data and specifications, costs, schedules, and possibly Team membership requirements. In short, the requirements for the design and development of the Project.

Typically, Development Plans are for Projects that result, if successful, in a product or a process. Each Development Plan will have tasks and issues that are specific to the results anticipated, and such will be known to those skilled in the art. As a Development Plan is implemented, the Plan's relationship to the DW Opportunities must be used to ensure that the Project remains on track.

Generally, Development Plans can be split into projects that result in a product and those that result in a process. The term “project” has been used to refer to either result, but the present discussion illustrates the difference between the two.

In particular, the Development Plan for a product will usually include: the Product Line affected; the current stage in the development (e.g., concept, Definition, Design, samples, pre-production, etc.); products inclusive in this Project; other products negatively (obsoleted) or positively (synergism) affected; Team members; and some projections on launch, and release timing, including if the Project is canceled or paused. The Project Status, described elsewhere, will include the actual status of these categories.

The BC data will include the R&D design/process/development/capital costs and any corresponding related costs, e.g., testing, etc. The Plan will include, a projection of the total market (TAM), the share of the market available (SAM) for this product and the % that the corporation is anticipated to win. Selling price (ASP), standard and variable costs, margins, yields, etc., may all be within the Plan.

Development Plan—Processes

The Development Plans for “processes” is a Form that shares common elements with such plans for products, but with some differences. The differences will be enumerated and may include: type of process and its relationship to standard corporation processes; related projects; where the process will be developed and the Product Line affected. The Project Status, described elsewhere, will include the actual status of these categories.

In particular, the following may be included in a Development Plan: projected dates of completion of the development steps; personnel costs, capital costs, material costs, sub-contractor costs, testing and qualification costs and any other development costs.

Retrieval And Viewing Of NPR's

The present invention provides software modules for navigating to any NPR. Note, the creation and implementation of the software module will be known to those skilled in the art and the modules may consist of commercially available modules or those particularly created for the present invention. The present invention, at least, provides a list of all NPR's by name and ID No.; a search engine with virtually all fields available for searching by key words, names etc.; “My” NPR's (those where the interrogator is identified by a logon/password or by a terminal or web address, etc.); and a link to related projects and ID's of related DW's.

Related Documents

As mentioned, documents contain information important to projects, but such documents are controlled by other corporate functions, e.g., DW's are generated and controlled by sales. The present invention facilitates the attaching, deleting and viewing of these documents from the present invention. The attached documents are identified by title, uploading date, relevant product or process and the type of document. For example, the types of documents may include: specifications, manuals, verification reports, test reports and characterization descriptions/data. Links in the present invention and knowing the format of the documents may collect the information from the documents automatically, but some data or information may be manually loaded.

Authorizing a Project and Authorizing a Project's Release to Production

When an NPR results in a new project formation, as discussed above, the project Team will, at least, create a Marketing Plan, a Development Plan and a BC. The decision to initiate the project is made by the Product Line management or the Development group responsible for such development. This responsible group will select a Project Leader and enter the corresponding data into the OBC system. The Project Leader or the group will name the Project, describe the Project and select, identify and enter the Project Team members. Furthermore, the Team will enter the ID's of related NPR's, DW's, related Projects, and lists of products that will be affected negatively and positively by the project.

Occasionally a Project may be split. Usually this is because some of the products resulting from the Project may not be ready to move through to commercialization. In this case, another Project is named and products identified. Typically, both Projects return to unapproved status and each traverses the NPR process discussed above. But, implementation may be flexibly applied depending on the projects.

The persons responsible for completing and for later updating the various forms may do so by filling in the blanks in the forms directly accessible from the web. However, a wizard may be used that is interactive to guide filling out or creating the forms. Both such techniques are known to those skilled in the art.

Once the Marketing and the Development Plans have been generated and the Product Line and/or the Development Group and Corporate management have enough information and data, the Project may be authorized. A list of persons, discussed below, whose approval is necessary is determined separately for each project. Generally, the Project Leader will approve development first, and the others are automatically e-mailed, or otherwise notified, and if enough or all approve the Project Status is changed to reflect the approval. The Project, however, may wait, in a “pool” of projects, until the required resources are available before the Project actually begins.

The steps are nearly the same for releasing a completed project to “Production.” The same functional groups, the Product Line and/or the Development Group and the Corporate management all agree to authorize the release. A list of persons, usually different from the above list, must have enough information and must all agree and the Project is released. Often the Project is sent back for further development or the project may be “killed.” The Corporate management may exercise power to release, to send back or to kill the project regardless of the opinions of the other groups.

Updating a Project for Comparisons of Actuals and Projections

Actual sales and BBB data will be entered into the Data Warehouse and are available for the present invention to access for generating comparisons.

Data from documents, like DW's, attached to the project is available for comparisons.

Data entered into the present invention regarding development costs and times is available.

Comparison software is available for comparing virtually any field and any data within the stored OBC information, either projections or actuals. Moreover, comparisons to past projects culled using virtually any criterion can be made, and cumulative data and information presented.

Archival of Projects

Preferred embodiments of the present invention will automatically archive any project. Often the projects archived are only those that have been released to manufacturing.

Monitoring the Project

Any project may be monitored via a display attached to a terminal with access to the web coupled to the present invention server. The user will logon and see his screen, called MY OBC. This first screen will remind the user of any NPR's and/or Projects that require a present or future action or an input from the user. It will also present recent notifications and alerts that have been entered on the projects.

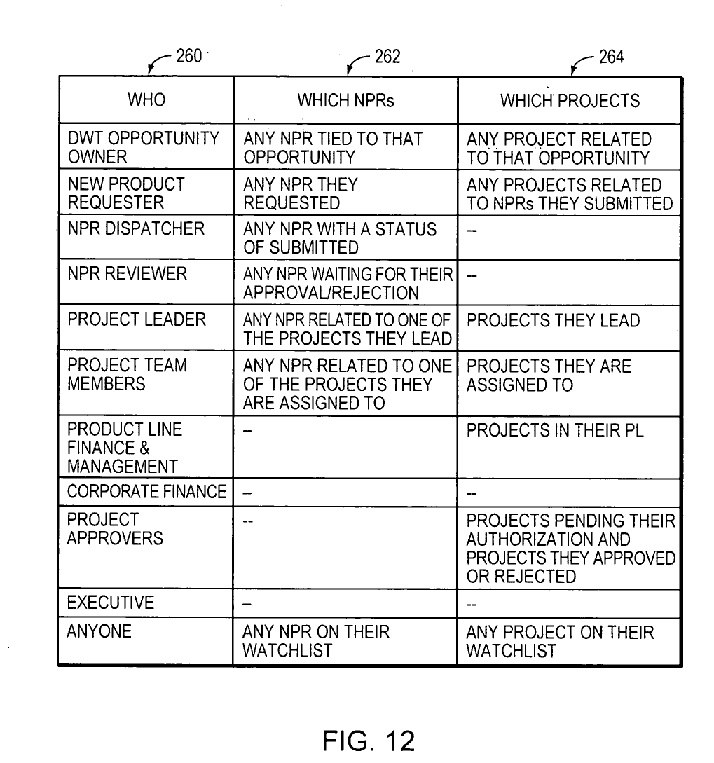

FIG. 12 is a table of those who might be users. The first column 160 details specific users, the second column 162 lists those NPR's, and the third column lists the projects associated with the user and/or the NPR's. Any one individual may fill different roles on different projects or within a project. In a preferred embodiment, the different rows may be highlighted via color, bold type or other ways to draw the user's attention to projects waiting for the user's response, projects deemed “at risk,” and to neglected projects.

Project Parameters and Metrics

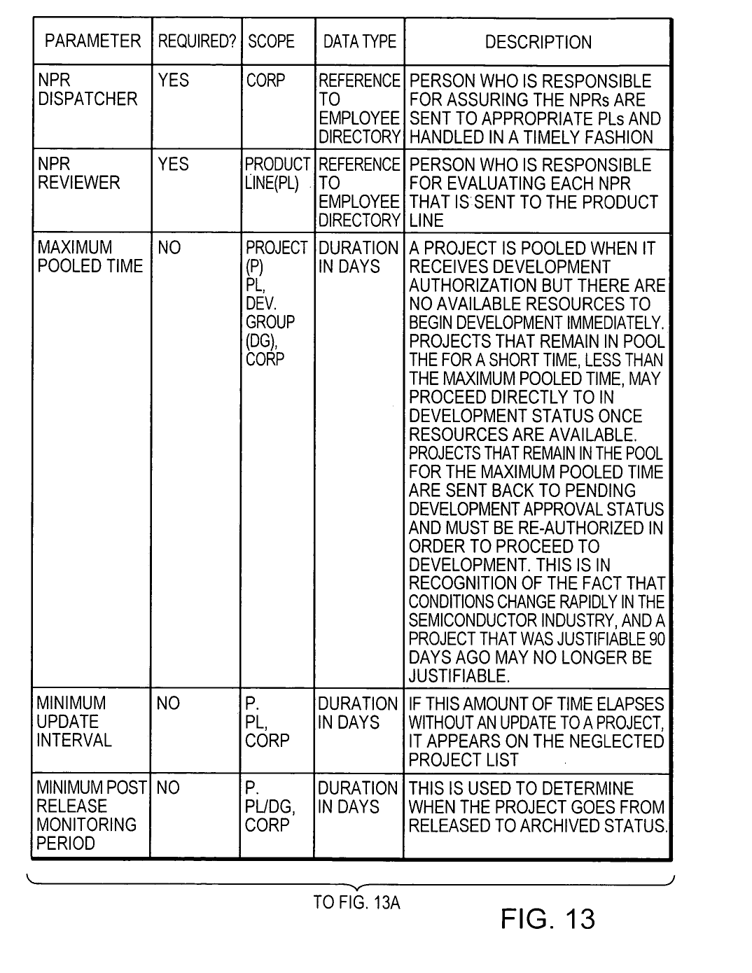

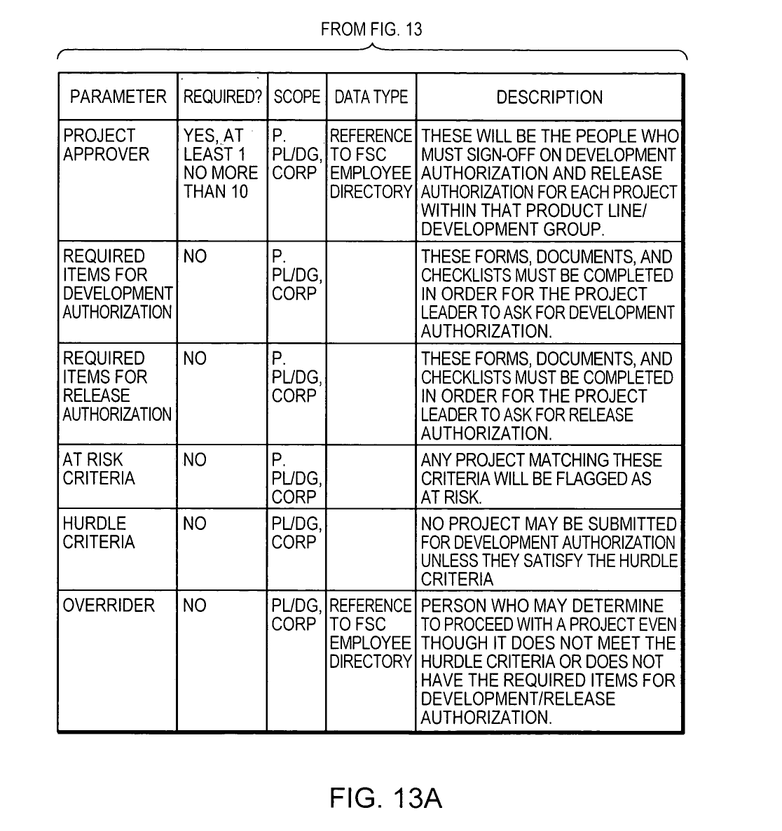

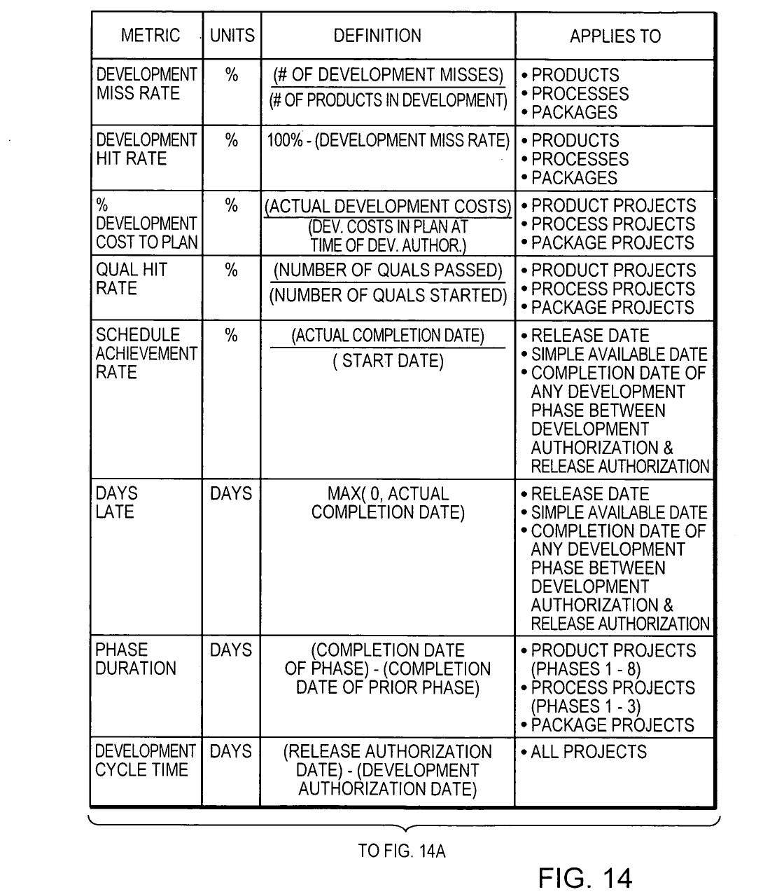

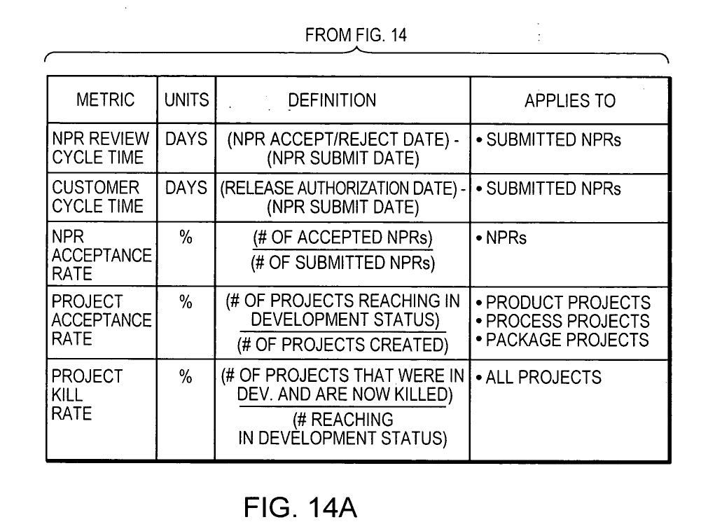

FIG. 13 is a table of preferred parameters associated with projects. These parameters are set with three different hierarchical levels or scopes where, generally, higher levels trump the lower levels. The lowest level is the Project, the next higher is the Product Line and the highest is the Corporate.

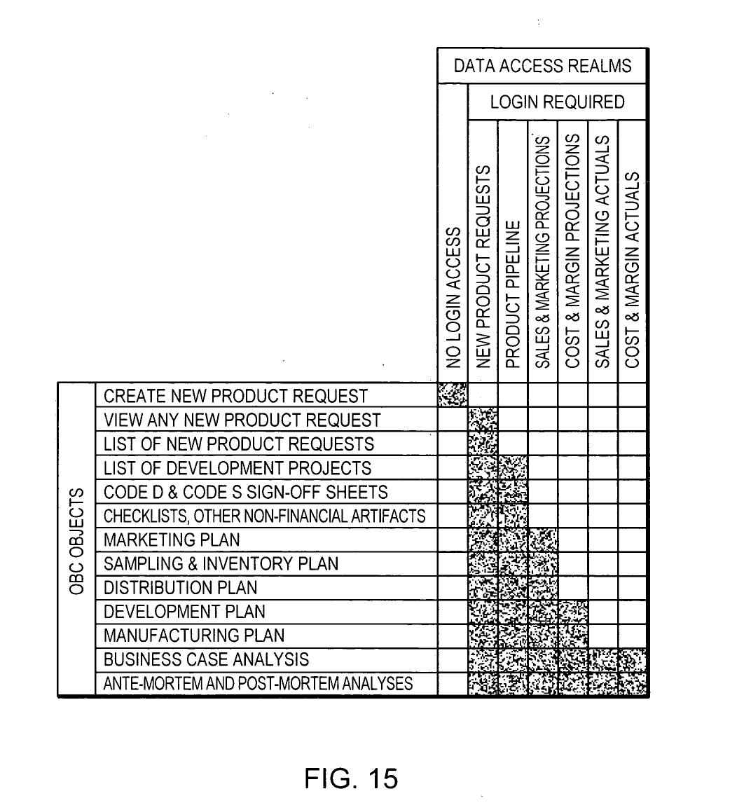

FIG. 15 is a table of preferred metrics, although others may be generated and used to advantage. Some metrics are understandable directly from their names, e.g. the Count of the Projects, or the iterations, etc. These metrics are common to and used throughout the various reports, forms and anywhere data is to be entered and/or compared.

Reports

The present invention supports and facilitates aggregating totals over a group of projects. Such aggregation may be used for forward projections of revenue, costs, timing of products, etc. Projects may be grouped by Type, Product Line, Division, Product Family, projects related in specific ways, release date and total R&D estimates of resources and capital. Examples of some of the relevant fields that may be searched and grouped include: Revenue, Margins, Volumes, Costs, the count of projects, Divisions affected, product lines, Sales regions, Market segments, Fabrication/manufacturing type and location, Customers, Year/quarter/period, and the Status of the projects.

Reports may be generated that facilitate reviews that look backwards and forward and that can be compared.

Reports may be generated that analyze or outline data, for example: Project cycle time, Development cycle time; NPR acceptance/rejection rates and ratios; Design hit rates; NPR response time; Success rates (for example with respect to DW's); Sales forecast accuracy and Scheduling accuracies.

Ad hoc reports may be generated from any data available to the present invention system, and all data may be presented in comparison to projected and actual data.

User Interface

The user requires a terminal with a display on a network with access to the computer hardware/software that comprises the present invention. The operating system, e-mail server and web browser of the user may be readily available modules from a variety of sources. Of course, they must be compatible with each other, and must be compatible with the interfaces used for the Data Warehouse and other corporate on-line functions.

External System Interfaces

The present invention must interface with the DW application maintained within the sales/marketing functions of the corporation. The DW will be one or more documents to the present invention, one being the tracking of specific competitors and/or their products, another one being the opportunity presented and the product specifically to attack that competitor.

The present invention should interface with software applications that are fundamental to the control, monitoring and reporting, etc., of the present invention. For example, the R&D function may have software applications that track the design and development of products or processes including, for example, time, cost and resources. The present invention must interface with such software application to receive the information described herein. At least the information that the project is stopped or killed, authorized at various levels described herein and the projected and actual costs and timeline.

The present system must be able to attach documents, preferably by reference.

Data Retention and System Performance

The system should generally retain all the information associated with any project. However, some data may be removed under conditions that may be determined in an ad hoc manner. For example, NPRs that were never submitted for approval or NPR's that were never projects after some time period (e.g., a year).

The system should handle a magnitude of more than ten thousand NPR's per year, expect hundreds of users, and may use off-line long term storage, but many years of past operations should be planned.

Authorized Access to the Present Invention

Each user will typically have a username and password to access the inventive system. In one preferred embodiment, access is divided into six levels, the levels being: NPR's, Products in Development, Sales and Marketing projections, Cost and Margin projections, Sales and Marketing actuals, and Cost and Margin actuals. Different persons involved with any particular project may be granted access to any or all the levels, or may be restricted to none, one or more. Of course high level management may have access to all levels. Typically, a mechanism will be used to log who, what and when individuals access the information.

In order to encourage new NPR's any employee may access the pages necessary to create new NPR's. FIG. 15 illustrates where a login is required. After a successful login, access is granted and the user may view all the information. In other preferred embodiments, such access may be selectively granted.

Hierarchical Access

In practice, additional powers may be granted as follows: a) some will be able to create business (marketing, development, etc.) plans; b) others may only be able to read or view some or all of them; c) Team members may have expanded access; d) specific relationships may grant some expanded access (like a sale person creator of an NPR); e) some may be able to update information; f) some may delete, and g) some may list information.

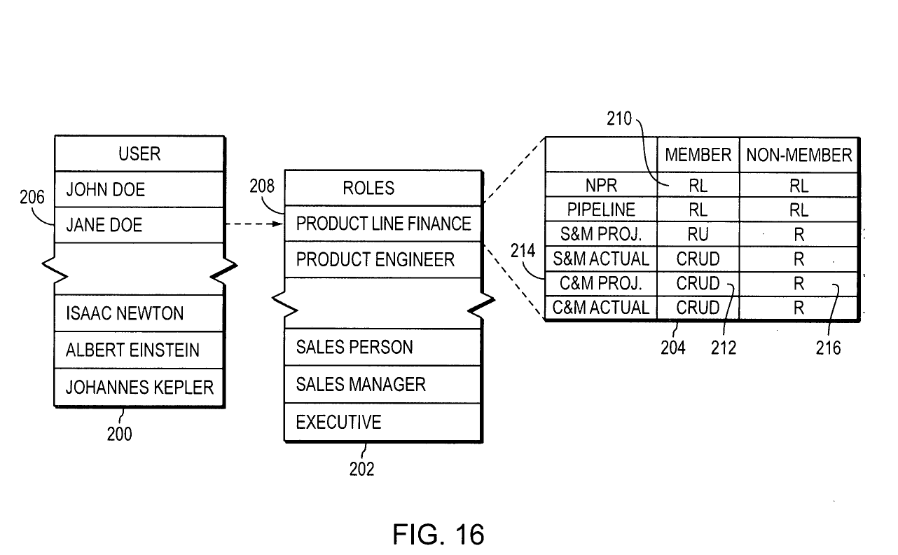

FIG. 16 illustrates mapping (known technique to those skilled in the art) of potential users 200, their roles 202 in a project, and their access and rights to the information 204. For example, John Doe 206 may be a project Team member in the role of Product Line Finance 208. In such a capacity, he may only be granted access rights to read and list (RL) 210 the NPR. But, he may be granted power to create, read, update, and delete (CRUD) 212 the cost and margin (C&M) 214 associated with the project. If he is not a Team member he may only be able to read the C&M 216. In the table, S&M refers to sales and marketing, and “pipeline” refers to a list of products in development. Of course other people in different functions may have more or fewer such rights.

The following are a sampling of common vocabulary terms that are preferentially used in preferred embodiments of the present invention. There may be overlap with the metrics, but the terms with meanings are:

At Risk Project

A Project that received Development Start approval bus has since failed to satisfy hurdle criteria or has deviated from the approved financial projections or timeline. Archived Projects are excluded.

Average Selling Price (ASP)

Semiconductors are not normally sold at fixed prices. The price is negotiated depending on the volume of sales, security of the business, exchange rate risk and other factors. Thus, it is impossible to identify a single price for a given product. Average Selling Price, the average of all the prices at which a given product is sold, is used the metric used to measure the unit pricing of products.

Bookings, Billings, and Backlog (BBB)

Revenue data

Business Case (BC)

As described above, a document or form providing the background information for a Project and the rationale behind investing in it.

Design Miss

A product development metric. A Design Miss is: 1) Any product opinion which requires a material change to the product, package, or process in order to be releasable—e.g., a mask change is required; and 2) Any product stopped and removed from the development line due to an inability to achieve a required specification or performance characteristic.

Design Wins Tracking (DT)

A software package currently in production that is used by the sales force to track sales leads.

Development Plan

The Project artifact that details the development of the Project, including projected costs and milestone dates.

Development-Cycle Project Tracking (DCPT)

a form or document that provides tracking and costing of product development projects.

Document

See definition above.

BBB

billings, booked, and backlogged sales data.

Form

See definition above. A Form is a body of information collected in a structured way, typically using a web form with individual fields for various pieces of information. Because Forms are structured they can be manipulated.

Production

A unit responsible for manufacturing.

Information Access Portal (IAP)

The shared web applications infrastructure.

Interested Parties

The list of people who receive updates regarding a Project and who see the Project in their My Projects list. This may include: Project Team Members, Requesters of all related NPRs, owners of all related DW's, etc.

Marketing Plan

The Project artifact that details the expected sales environment of the Project, including a list of charter customers and projections of sales volume and unit pricing.

Neglected Project

A Project which has not been updated within a time indicated by the Project, Product Line/Development Group, or corporate levels.

New Product Request (NPR)

A request that an idea for a new part be considered for further evaluation.

Orderable Part Number (OPN)

Original Schedule Date (OSD)

A milestone date or date of completion for a task or phase in one of the Project Plans as they were when Development Authorization was granted.

Post-Release Monitoring Period

The time after a Project is Released when it is monitored closely to confirm that sales are meeting the expectations set in the Marketing Plan.

Product-Process

See definition above.

Product Line (PL)

An organization unit.

Product Requirement Specification (PRS)

Document describing the specifications the customer requires the Product to satisfy.

Project ID

A unique identifier generated by the present invention for each Project.

Project Leader

The person responsible for creating and administering a Project.

Served Available Market (SAM)

That part of the total market covered by the Company's product range (see also TAM: Total Available Market)

Serviceable Available Market

A synonym for Served Available Market.

Share of the Market (SOM)

A particular product's share of an industry's volume usually expressed in sales or number of units sold.

Team Member

One of the people assigned a role for a give Project.

Total Available Market (TAM)

The entire accessible market for a given product (see also SAM: Served Available Market).

Watchlist

A list of Projects and NPRs that a user would like to monitor closely.

Wizard

A special mode for completing a Form which provides guidance and examples for how each field should be completed. More generally, an interactive help utility that guides a user through a potentially complex task, such as configuring a driver to work with a new modem. Wizards are often implemented as a sequence of dialog boxes which the user can move forwards and backwards through, filling in the details required.

It should be understood that above-described embodiments are being presented herein as examples and that many variations and alternatives thereof are possible. Accordingly, the present invention should be viewed broadly as being defined only as set forth in the hereinafter appended claims.

What is claimed is:

1. An on-line computerized process having an application protocol for managing a project from a computer system over a computer network using a transport protocol, the process comprising the steps of:
requesting, justifying and defining a new project;
developing and tracking of business and technical milestones;
flagging and monitoring of business and technical milestones;
computing costs, timing and other relevant items with respect to the project including the finished product or process;
entering actual data and other information as it becomes available;
creating thresholds for any or all of the flagged items;
determining persons and times for reviewing and approving the project; wherein the persons are selected from across the companies functional groups, and
storing all the data, projections and actuals, comparisons, descriptions, analyses and other relevant information in a central storage facility, wherein all such contents of the central storage facility share common metrics, common vocabularies, and wherein relevant information is readable, and further where such relevant information is accessible according to a hierarchical order.

2. The on-line computerized process of claim 1 wherein the step of defining a new project includes the steps of:
creating a set of requirements for the project;
generating a marketing plan;
generating a Development Plan, and
generating a business case.

3. The on-line computerized process of claim 2 wherein the step of generating a business plan includes the steps of:
generating an executive summary; a description of: the marketing environment, the competitive strategy and positioning, a financial projections, an Implementation Summary and supporting materials.

4. The on-line computerized process of claim 3 wherein the step of generating the executive summary includes the steps of condensing a project description, a status summary, a forward looking financial status, and forward looking cash flow projection, a project timetable, a Sensitivity Analysis and a Risk Assessment on a single page.

5. The on-line computerized process of claim 1 further comprising the steps of interfacing the central storage facility to the communications network, and accessing the central storage facility via an interfacing protocol.

6. The on-line computerized process of claim 5 wherein the communications network is the Internet or a private network.

7. The on-line computerized process of claim 1 further comprising the steps of:
automatically notifying selected corporate functions when any of the thresholds are violated.

8. The on-line computerized process of claim 1 further comprising the step of organizing the stored data in the central storage facility, wherein each project includes information arranged as attributes, forms, documents, analyses and checklists.

9. The on-line computerized process of claim 1 wherein the business and technical milestones includes critical costs, times and other critical items.

10. The on-line computerized process of claim 1 further comprising the steps of:
identifying competitive products or processes or a business opportunity that is targeted by a project, and tracking the competitive products and opportunity as the project progresses.

11. The on-line computerized process of claim 1 further comprising the steps of generating from the stored information an ante-mortem for the project, and generating a post-mortem for the project at any time near the end of a project or when any resulting product of products are obsoleted or when a resulting process or processes are superseded, and comparing the ante and post mortems.

12. The on-line computerized process of claim 1 further comprising the steps of storing past projects and providing the links and programs to compare present and past projects.

13. The on-line computerized process of claim 1 further comprising the step of summing the contents in the central storage facility to generate a cumulative view of the corporation.

14. The on-line computerized process of claim 1 wherein the computer system comprises a server-client configuration.

15. An on-line computer system having an application protocol for managing a project over a computer network using a transport protocol, the process comprising the steps of:
a terminal interfaced to the computer system for requesting, justifying and defining a new project;
software resident in the computer system, the software arranged for:
developing and tracking of business and technical milestones;
flagging and monitoring of business and technical milestones;
computing costs, timing and other relevant items with respect to the project including the finished product or process;
entering actual data and other information as it becomes available;
creating thresholds for any or all of the flagged items,
determining persons and times for reviewing and approving the project; wherein the persons are selected from across the companies functional groups, and
a central data storage system for storing all the data, projections and actuals, comparisons, descriptions, analyses and other relevant, wherein all such contents of the central storage system share common metrics, common vocabularies, and wherein relevant information is readable, and further where such relevant information is accessible according to a hierarchical order.

16. The on-line computer system of claim 15 wherein the software for defining a new project includes:
a set of requirements for the project;
a marketing plan;
a development plan, and
g a business case.

17. The on-line computer system of claim 16 wherein the business plan includes:
an executive summary; a description of: the marketing environment, the competitive strategy and positioning, a financial projections, an implementation summary and supporting materials.

18. The on-line computer system of claim 17 wherein the executive summary includes:
a project description, a status summary, a forward looking financial status, and forward looking cash flow projection, a project timetable, a sensitivity analysis and a risk assessment, wherein the contents of the executive summary are condensed on a single page.

19. The on-line computer system of claim 15 further comprising an interface between the central storage system and the communications network, and an interfacing protocol allowing access therebetween.

20. The on-line computer system of claim 15 further comprising means for automatically notifying selected corporate functions when any of the thresholds are violated.

21. The on-line computer system of claim 15 wherein the stored data in the central storage system includes information, each project, arranged as attributes, forms, documents, analyses and checklists.

22. The on-line compute system of claim 15 wherein the business and technical milestones includes critical costs, times and other critical items.

23. The on-line computer system of claim 1 further comprising means for identifying competitive products or processes or a business opportunity that is targeted by a project, and means for tracking the competitive products and opportunity as the project progresses.

24. The on-line computer system 5 of claim 15 further comprising an ante-mortem for the project generated from the stored information, and
a post-mortem for the project generated that may be generated at or near the end of a project or when any resulting product of products are obsoleted or when a resulting process or processes are superseded, and
means for comparing the ante and post mortems.

25. The on-line computer system of claim 15 further comprising links and programs to compare present and past projects.

26. The on-line computer system of claim 15 wherein the contents in the central storage system provide a cumulative view of the corporation.

27. The on-line computer system of claim 15 wherein the computer system comprises a server-client configuration.
